(19) United States
(12) Patent Application Publication
(10) Pub. No.: US 2016/0318786 A1
(43) Pub. Date: Nov. 3, 2016

(54) PORTABLE WATER PURIFICATION SYSTEM

(71) Applicant: Embry-Riddle Aeronautical University, Inc., Daytona Beach, FL (US)

(72) Inventors: Marc Damon Compere, Orlando Beach, FL (US); Yan Tang, Port Orange, FL (US); Shavin Pinto, Portland, OR (US); Yung Wong, Iselin, NJ (US)

(21) Appl. No.: 15/206,526

(22) Filed: Jul. 11, 2016

Related U.S. Application Data
(63) Continuation of application No. PCT/US2015/011101, filed on Jan. 13, 2015.
(60) Provisional application No. 61/926,796, filed on Jan. 13, 2014.

(51) Int. Cl. C02F 9/00; C02F 1/28; C02F 1/44; C02F 1/00

(52) U.S. Cl. CPC C02F 9/005; C02F 1/001; C02F 1/283; C02F 1/444; C02F 2201/009; C02F 2209/03

(57) ABSTRACT

An ultra-portable water purification system (1). The system (1) can include a pump (22) for pumping water under pressure through the water purification system (1). The system (1) can also include a battery (14) for supplying power to operate the pump (22), a power source (10) for providing power to the battery (14) and the pump (22), and a charge controller (18), electrically connected to the power source (10), battery (14), and pump (22), for regulating power received from the power source (10) and limiting the power provided to the battery (14) to power the pump (22). The water purification system (1) can also include a mesh strainer (20) upstream of the pump (22), a sediment filter (26), and an electropositive filter (30). The mesh strainer (20), sediment filter (26) and electropositive filter (30) are arranged in series such that the source water is pumped sequentially therethrough.

### CROSS REFERENCE TO RELATED APPLICATIONS

The present Patent Application is a continuation application of previously filed, co-pending PCT Application No. PCT/US2015/11101, filed Jan. 13, 2015, entitled “Portable Water Purification System” which PCT application claims the benefit of U.S. Provisional Patent Application Ser. No. 61/926,796, filed Jan. 13, 2014 by the inventors named in the present Application. This Patent Application claims the benefit of the filing date of the cited Provisional Patent Application according to the statutes and rules governing provisional patent applications, particularly 35 U.S.C. §119(e), and 37 C.F.R. §§1.78(a)(3) and 1.78(a)(4). The entire disclosures of both PCT Application No. PCT/US 2015/11101 and U.S. Provisional Patent Application No. 61/926,796 are specifically incorporated herein by reference as if set forth in their entirety.

### TECHNICAL FIELD

Embodiments of this disclosure generally relate to a portable water purification system and, more specifically to a lightweight water purification system that can be carried in a backpack.

### BACKGROUND

Water is an essential life-sustaining resource. World populations face growing water scarcity concerns, particularly in developing countries. Natural disasters pose another factor in limiting water availability, even in well-developed countries. The biggest issue that arises pertains to quality of water available under the aforementioned conditions. After natural disasters and in under-developed countries, water resources face issues with contamination. This contaminated water proves unsuitable for consumption.

Developing countries account for a large portion of the world's population. The Human Development Index lists 85 out of 169 countries as “very high human development” or “high human development” in its 2010 Human Development Report. For less developed countries, water sanitation poses a major issue. In countries such as Haiti, villages have ready access to fresh water sources in the form of streams and standing water. However, this fresh water harbors water-borne illness in the form of viruses and bacteria. The turbidity in streams and standing bodies of water also renders these sources undrinkable. Philanthropic efforts from individuals and companies have aided villages in providing means for purifying water for consumption, yet a large majority of populations continue to receive little to no attention. The philanthropic efforts also may not prove substantial enough to offer a permanent solution. Natural disasters render large drinking supplies unsanitary, affecting large populations in the affected areas. Worldwide, approximately one out of every eight people is restricted from potable water resources, representing a total close to one billion people. Close to four million of the world's population die from water-borne illnesses each year, most of whom are children under 5. These statistics clearly indicate that a dire need exists for engineered systems that can take available water resources and produce safe, consumable water. Water purification devices exist in the consumer market; however, factors, such as portability and efficiency, limit the practicality of a large portion of the available devices.

Ultraviolet (UV) filtration is the most popular method of filtration for purifying water in portable water systems. However, implementing UV filtration in a portable water purification system is problematic due to the rugged conditions under which the portable water purification system must operate. In particular, installation of a UV lamp is a very delicate process and in a post-disaster scenario, ruggedness is a primary consideration. The UV lamp is unlikely to withstand the vibrations and impacts sustained through transportation of the water purification system without substantial protection.

### SUMMARY

The disclosed embodiments provide a number of unique features in a portable water purification system including, but not limited to, high flow rates, unique arrangement of components, lightweight, suitability for a rugged environment, and self-sustainability.

According to one embodiment, the disclosure provides a portable water purification system comprising a pump for pumping water under pressure through the water purification system. The system can also include a battery for supplying power to operate the pump, a power source for providing power to the battery and the pump, and a charge controller, electrically connected to the power source, battery, and pump, for regulating power received from the power source and provided to the battery to power the pump. The water purification system can also include a mesh strainer upstream of the pump, a sediment filter, and an electropositive filter. The mesh strainer, sediment filter and electropositive filter are arranged in series such that the source water is pumped sequentially therethrough.

According to another embodiment, this disclosure provides a portable water purification system comprising a purification unit and a power unit. The purification unit comprises a mesh strainer, a sediment filter, and an electropositive filter arranged in series such that source water passes sequentially therethrough. The purification unit also includes a pump for pumping water under pressure through the water purification system. The power unit includes at least one of a power source and a battery for providing power to the pump.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates a schematic of a portable water purification system according to embodiments of the present invention.

FIG. 2 illustrates a purification unit of the portable water purification system according to embodiments of the present invention.

FIGS. 3A-3D illustrate a perspective, right side, front side, and top views respectively of a fitting for mounting a pressure gauge to the purification unit according to embodiments of the present disclosure.

### DETAILED DESCRIPTION

The following description is provided as an enabling teaching of embodiments of the invention. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

The disclosed embodiments provide a number of unique features in a portable water purification system including, but not limited to, high flow rates, unique arrangement of components, low cost, lightweight, suitability for a rugged environment, and self-sustainability.

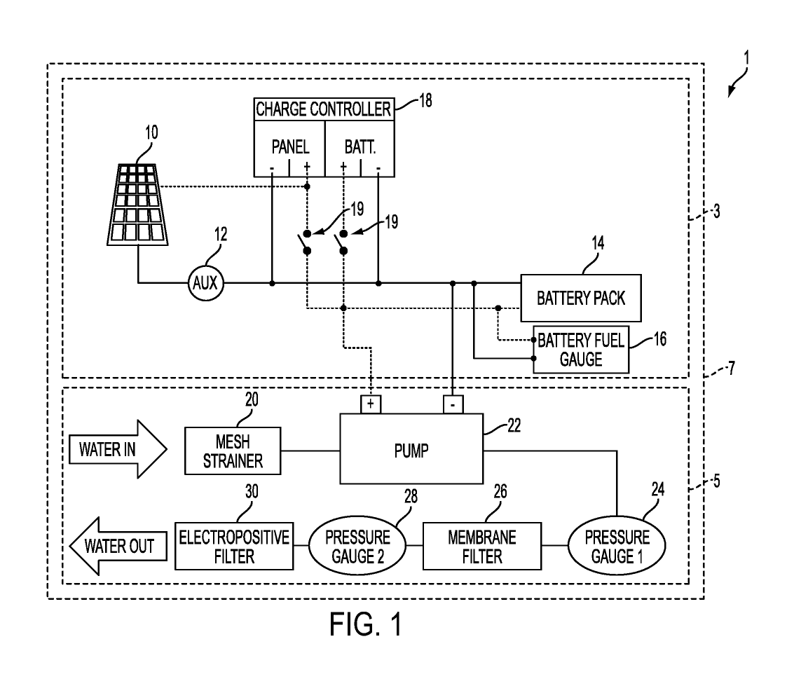

FIG. 1 illustrates a schematic of a portable water purification system 1 according to one embodiment. The components of the water purification system 1 will be described in greater detail below. The water purification system 1 can include a power unit 3 and a purification unit 5, both of which can be removably contained within a carrier 7 for transportation thereof. The power unit 3 can include a power source 10, such as a foldable solar panel. The power unit 3 can also include an auxiliary port 12. The auxiliary port 12 may provide a connection to an alternative power source, such as the electrical grid or gas generator. Alternatively, or in addition, the auxiliary port 12 may provide power to external devices, such as cellular phones. The auxiliary port 12 may be a 12 V port. The power unit 3 may also include a battery 14, a battery fuel gauge 16 to inform the user of the state of charge of the battery 14, a charge controller 18 and one or more circuit breakers 19. The circuit breakers 19 can function as on/off switches, reset switches, emergency breakers, or the like. The power source 10 can supply power to the pump 22 and charge the battery 14 through the charge controller 18.

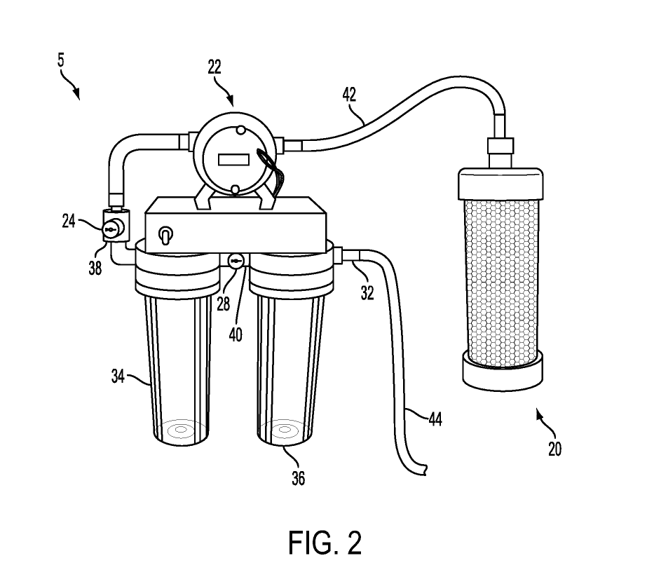

The purification unit 5 can include a mesh strainer 20 functioning as an inlet, a pump 22, a first pressure gauge 24, a sediment filter 26, a second pressure gauge 28, and an electropositive filter 30 arranged in series between a water source and a potable water outlet 32 (see FIG. 2). The pump 22 operates to pull water from the source through the mesh strainer 20 and provide pressurized water to the sediment filter 26 and the electropositive filter 30 to remove harmful contaminants.

In one embodiment, a 12 V pump can be selected. Various categories of pumps could be considered including electric submersible, diaphragm, electric inline, siphon, inline mechanical, piston mechanical, and gravity fed. Preferably, the pump 22 should provide at least two gallons per minute with an average pressure of 30 psi. In some embodiments, the pump 22 should (1) draw no more than 12 amperes maximum at an output pressure of 70 psi, (2) run continuously for a full battery cycle at 100% state of charge without overheating, (3) weigh less than 10 pounds, and (4) be self-priming. The pump 22 should avoid sustaining damage from sediment intake. In a preferred embodiment, a pump 22 is a 12 V diaphragm transfer pump, such as a 550 Series high flow, diaphragm transfer pump available from Aquatec.

### Filtration

The water purification system 1 can utilize a three-stage filtration process to purify water to meet drinking water standards. With reference to the embodiment shown in FIG. 1, the first filtration stage includes a mesh strainer 20 which blocks entry of large items found in the water supply such as sticks, clumps of dirt, etc. The second filtration stage can include a sediment filter 26 which further removes particulate material. The third filtration stage can include an electropositive filter 30 which rejects particulate matter larger than about 0.02 microns for up to LOG 6 removal, or 99.9999% of microbiological contaminants.

The first stage of filtration is provided by a mesh strainer 20 which is intended to be placed directly in the source water upstream of the pump 22. The mesh strainer 20 may be stainless steel. In some embodiments, the mesh strainer 20 may be multi-layered, with each successive layer having a smaller mesh. In some embodiments, the layers of mesh remove contaminants larger than about 60 microns. In one example, the mesh strainer can include three different sizes of meshes: a ¼ inch hole size mesh, a “20 mesh”, and a “50×250” mesh. The ¼ inch hole size mesh is the outside layer which prevents large particulates such as sticks and leaves from getting through to the other layers of the mesh strainer 20. The “20 mesh” layer may be welded to the “50×250” mesh layer. The “20 mesh” layer filters particulates down to 850 microns. The “20 mesh” layer also provides structure for the 50×250 mesh which filters particulates down to 60 microns.

The second stage of filtration utilizes a sediment filter 26 in the illustrated embodiment. Preferably, the sediment filter 26 is a pleated membrane filter configured to remove particulates larger than two microns, and preferably larger than one micron. Preferred sediment filters may include reverse osmosis, nanofiltration, and ultrafiltration membrane filters. The sediment filter 26 may have electropositive filter media that uses two mechanisms to remove contaminants from water. First, a size exclusion mechanism is used to remove particulates larger than 2 microns. Second, the potential difference between the filter media and the contaminants attracts the contaminants to the filter wall effectively removing contaminants larger than 0.02 microns from the water.

A membrane filter, such as the sediment filter 26 or the electropositive filter 30 may be made from a type of polymer, therefore, it is more rugged and more resistant to damage from drops and vibration than UV lamps. Membrane filtration is a pressure-driven separation process in which particulate matter is rejected by an engineered barrier which has a measurable removal efficiency of a target organism that can be verified through the application of a direct integrity test. An added benefit of using membrane filters for disinfection is that it completely removes the microbiological bodies from the water, whereas the UV lamp deactivates them but leaves the bodies suspended within the water. This benefit of the membrane filter will give consumers greater peace of mind

The third stage of filtration can include an electropositive filter 30. In preferred embodiments, the electropositive filter 30 comprises a pleated membrane. In preferred embodiments, the electropositive filter 30 comprises powder activated carbon. Therefore, the electropositive filter 30 may be described as having an antimicrobial source and fibrous structure having activated carbon powder. Use of activated carbon powder in the pleated cartridge filter reduces chemical contaminants (e.g., chlorine, iodine, volatile organic compounds) and also improves taste and smell. For effective removal of bacteria, viruses, and cysts, a membrane having a size around 0.02 micron should be utilized. In some embodiments, the electropositive filter 30 may include a carbon core. An electropositive filter 30 suitable for this use is sold under the trade name NanoCeram-PAC™ available from Argonide Corporation and is disclosed in patent publication US 2007/0175196A1. This filter is capable of absorbing chromium, iron, nickel, tin, zinc, uranium, vanadyl specis, dissolved halogen, and fluoride ion. It is also capable of filtering radioactive metals, as well as lead, arsenic, and other toxic metals.

### Purification Unit

The purification unit 5 can include a pair of filter housings 34, 36, one each for the sediment filter 26 and electropositive filter 30. FIG. 2 illustrates an exemplary purification unit 5. The two filter housings 34, 36 are assembled in-line (i.e., in series) with each other. The purification unit 5 also includes a first and second pressure gauge 24, 28. The pressure gauges indicate to the user when to change the filters in the housings because the filters have become clogged. Miniature pressure gauges are preferred because digital gauges are expensive and may not hold up to the vibrations and extreme temperatures in a rugged environment.

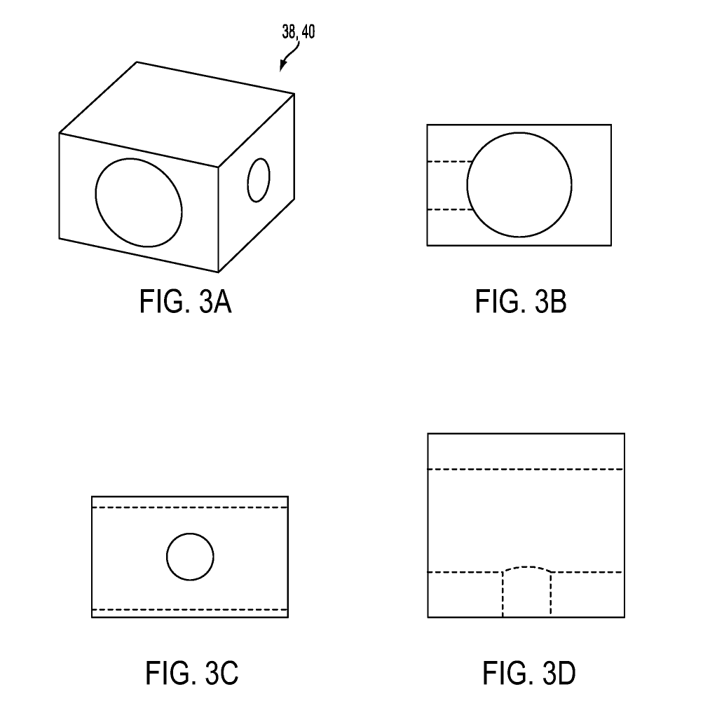

The purification unit further includes first and second fittings 38, 40 as illustrated in FIG. 3. The first fitting 38 is located at the inlet of the first filter housing 34. The second fitting 40 is located in between the two filter housings 34, 36. The two fittings 38, 40 are identical and serve to mount the pressure gauges 24, 28. The fittings are constructed to minimize the total number of required parts for the purification unit 5. The purification unit 5 can include an inlet hose 42 that connects the mesh strainer 20 to the pump 22. An outlet hose 44 may also be provided for connection to the potable water outlet 32.

In one embodiment, a chlorination system could be integrated into the purification unit 5 to mitigate potential bacteria growth within the system and within an end-user's water storage container.

### Self-Sustainability

In preferred embodiments, the water purification system 1 is self-sustainable. This means that it is able to power itself independently without relying on the electric grid or an outside source of power, such as fuel. Reliance upon the foldable solar panels as the power source 10 would constitute a sustainable system. The foldable solar panels reduce weight and increase transportability. Example foldable solar panels, rated for 120 W are available from Powerfilm Solar. This foldable solar panel can be carried easily in the carrier 7. In other embodiments, the water purification system 1 is not self-sustaining, and could rely on generators or external power from an electric power grid through connection with the auxiliary port 12.

With further reference to FIG. 1, in some embodiments, a combination of power source 10 and battery 14 is included inside the carrier 7 to power the pump 22. A charge controller 18 takes the power produced by the power source, e.g. solar panel, and regulates the charging of the battery 14. The charge controller 18 prevents overcharging, and with Maximum Power Point Tracking (MPPT), maximizes the energy harvested from the power source 10.

The battery 14 may comprise a 12 V, 5 Amp-Hour LiFePO4 battery with a 20 ampere protection circuit board (PCB). The PCB protects the battery from overcharging and over-discharging. Example batteries with protection circuit boards of this type are available from Ultralife.

### Ergonomics

To assist with the portability of the disclosed water purification system 1, it may include a carrier 7 capable of transporting substantially all of the disclosed components. The carrier may be either a soft case or hard case. A hard case that can be used to house the water purification system's components in one embodiment could be a plastic Pelican case or a Pelican-Hardigg case. These molded plastic containers seal with an airtight and watertight gasket. These molded plastic cases have a set of wheels and a retractable handle that would facilitate transportation over flat grounds. The internal dimensions of these hard cases are sufficient to accommodate all the components of the water purification system 1. Fiberglass hard cases have also been contemplated. The soft case could be a backpack having one or more shoulder straps.

Items placed inside the carrier 7 should be arranged in a manner that provides maximum comfort to the user while traveling. The heavier items should be placed at the top of the carrier 7 and in a symmetrical fashion. Embodiments of the present disclosure that include the foldable solar panel and a lithium-based battery have been found to weigh approximately 25 pounds. Embodiments without the foldable solar panel and battery weighed approximately 16 pounds.

### Testing and Experimentation

To determine an appropriate power source 10 and battery 14 for the water purification system 1, an Energy Time Analysis (ETA) could be performed assuming sunlight is available for 5 hr./day. This analysis is based on the conservation on energy. For conservative measure, solar panel efficiency of 77% is assumed. Efficiency will be reduced due to temperature and alignment with the sun. Battery storage efficiency of 95% is used because lithium-ion batteries can typically provide greater than 95% of the energy stored. The design variables and constraints for example power generating components of the water purification system are shown in Table 1.

TABLE 1
Power System Design Constraints
Design Constraints

| | |
|---|---|
| Flow Rate (gal/min) | 2.5 |
| Water Volume (gal/day) | 500 |
| Pumping Power (Watt) | 92 |
| Pump Runtime (hr) | 3.33 |
| Sunlight (hr/day) | 5 |
| Solar Panel Efficiency | 0.77 |
| Charge Controller Efficiency | 0.975 |
| Battery Storage Efficiency | 0.95 |

In an example embodiment, solar energy can be captured by a 120 Watt foldable solar panel to charge a 12.8 V, 5 Amp-Hour lithium iron phosphate (LiFePO4) battery with a maximum power point tracking (MPPT) charge controller. Using a MPPT charge controller, energy harvesting is maximized with a peak efficiency of 97.5%. The MPPT controller expands the capability of the system by being able to operate using solar power, battery, a combination of both, or a 12 V source via an auxiliary port. In some embodiments, the auxiliary port could be implemented to provide a means to charge small devices like cell phones and GPS devices as well as charge the battery with a battery charger adapter from the electric grid.

In one example, a 550 Series high flow, diaphragm transfer pump available from Aquatec was used. The 550 Series is designed for intermittent duty, but can run continuously for several hours. The 550 Series can be controlled by a pressure switch or an external power control device. To provide 2 gallons per minute, the 550 Series consumed about 50-114 watts. Pump wattage has a range due to the pressure needed to push the water through the filters. If the filters are clean, the pressure will be low and the pump will not draw as much current as if the filters are dirty. For preliminary design considerations, an average pump power of 92 W could be assumed. The power unit design is based on the power requirements of the pump 22. Using this assumed value in the calculations is believed appropriate because an ideal operating condition assumes that the filters are within 30%-60% of their capacity. To determine power requirements, an average flow rate of 2.5 GPM could be assumed. Table 2 shows the draw of the 550 Series pump for a given flow rate in gallons per minute. It could be assumed that an average person needs a minimum of 0.5 gal/day of water for survival. This translates to a requirement of 350-500 gal/day that needs to be pumped to provide water to up to 1000 people daily. To accomplish this requirement, the pump needs to run for approximately 2.3-3.3 hours.

TABLE 2
Pump Performance Data
AQUATEC 550 SERIES

| Discharge Pressure | | |
|---|---|---|
| (PSI) | Flow (GPM) | Current (Amps) |
| 50 | 2.1 | 9.5 |
| 40 | 2.3 | 8.5 |
| 30 | 2.5 | 7.2 |
| 20 | 2.75 | 5.8 |
| 10 | 3.05 | 4.6 |
| 0 | 3.35 | 3.2 |

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments are possible without departing from the scope of the present invention. In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims.

What is claimed:

1. A water purification system comprising:
a pump for pumping water under pressure through the water purification system;
a power unit operably connected to the pump for providing power to the pump;
a charge controller, electrically connected to the power unit and configured to regulate power received from the power unit and provided to power the pump;
a strainer upstream of the pump;
a sediment filter; and
an electropositive filter,
wherein the strainer, sediment filter and electropositive filter are arranged in series such that the source water is pumped sequentially therethrough.

2. The water purification system of claim 1 wherein the power unit comprises a solar panel for capturing solar power.

3. The water purification system of claim 1 wherein the power unit comprises a battery and a power source for charging the battery.

4. The water purification system of claim 1, further comprising a carrier, wherein the carrier comprises either a hard case or soft case and is configured to contain the water purification system.

5. The water purification system of claim 1 wherein the strainer comprises one or more layers of mesh which remove contaminants larger than about 60 microns.

6. The water purification system of claim 1 wherein the pump comprises a diaphragm transfer pump.

7. The water purification system of claim 1 wherein the pump operates on a voltage of about 12 volts and pumps at least two gallons of water per minute and has a maximum pressure of about 50 pounds per square inch.

8. The water purification system of claim 1 wherein the power unit comprises a battery having protection circuit board to protect the battery from over-voltage and under-voltage conditions.

9. The water purification system of claim 8 wherein the battery comprises a lithium-ion battery.

10. The water purification system of claim 8 wherein the battery comprises a 12 volt, 5 ampere-hour lithium iron phosphate battery.

11. The water purification system of claim 1 wherein the sediment filter comprises a membrane filter.

12. The water purification system of claim 11 wherein the membrane filter rejects particulate matter larger than about 2.0 micron.

13. The water purification system of claim 1 wherein the electropositive filter rejects particulate matter larger than about 0.02 microns.

14. The water purification system of claim 13 wherein the electropositive filter comprises a powder activated carbon filter to remove contaminants in the source water affecting taste and smell.

15. The water purification system of claim 1, wherein the power unit further comprises an auxiliary port configured to establish an electrical connection between the power unit and an auxiliary device.

16. The water purification system of claim 1 further comprising a pressure gauge to identify when the sediment filter is clogged.

17. The water purification system of claim 16 further comprising a fitting, the fitting is located at an inlet to a filter housing, the filter housing containing the sediment filter, the fitting mounting the pressure gauge.

18. The water purification system of claim 1 further comprising a pressure gauge to identify when the electropositive filter is clogged.

19. The water purification system of claim 18 further comprising a fitting, the fitting is located at an inlet to a filter housing, the filter housing containing the electropositive filter, the fitting mounting the pressure gauge.

20. A portable water purification system comprising:
a mesh strainer, a sediment filter, and an electropositive filter arranged in series such that source water passes sequentially therethrough;
a pump for pumping water under pressure through the water purification system; and
a rechargeable battery for providing power to the pump.
